(19) United States
(12) Patent Application Publication
(10) Pub. No.: US 2016/0142508 A1
(43) Pub. Date: May 19, 2016

(54) COMMUNICATION DEVICE, COMMUNICATION METHOD AND NON-TRANSITORY COMPUTER READABLE MEDIUM

(71) Applicant: KABUSHIKI KAISHA TOSHIBA, Tokyo (JP)

(72) Inventor: Takeshi ISHIHARA, Yokohama (JP)

(21) Appl. No.: 14/939,554

(22) Filed: Nov. 12, 2015

(30) Foreign Application Priority Data
Nov. 13, 2014 (JP) 2014-230992

(51) Int. Cl. H04L 29/08; H04L 12/26; H04L 12/801

(52) U.S. Cl. CPC H04L 67/2842; H04L 67/289; H04L 47/115; H04L 43/103; H04W 84/12

(57) ABSTRACT

According to one embodiment, a communication device includes: a wireless communication interface to transmit and receive a radio signal; a wireless monitor to measure a state of a communication channel with a counterpart device based on a frame to be communicated with the counterpart device via the wireless communication interface; a communication state determiner to determine whether to transmit information pre-acquired for the counterpart device to the counterpart device based on the state of the communication channel; and a communicator to transmit the information to the counterpart device via the wireless communication interface according to a determined result of the communication state determiner.

### CROSS-REFERENCE TO RELATED APPLICATIONS

This application is based upon and claims the benefit of priority from Japanese Patent Application No. 2014-230992, filed Nov. 13, 2014; the entire contents of which are incorporated herein by reference.

### FIELD

Embodiments described herein relate to a communication device, a communication method and a non-transitory computer readable medium.

### BACKGROUND

Wireless communication schemes typified by IEEE802.11 and LTE are widespread. In these communication schemes, equipment called an access point or a base station is used to connect wireless communication to a backend network constituted with a wired communication technique. The access point which serves as a bridge connecting different networks in a data link layer, mainly has a role of relaying a frame between a wireless side and a wired side and relaying a frame between different communication schemes. At this time, the access point generally does not store a frame for a long period of time and transfers a frame to a network of a relay destination immediately upon reception.

Meanwhile, a communication scheme (Content-Centric Networking: CCN) is suggested in which a router or a bridge located on a network has a cache function for temporarily storing data to be relayed and data is transmitted in a unit of a chunk of meaningful information. In this scheme, when information requested by a user is acquired, information closest to the requested information is selected from a plurality of caches located on the network, and information transmitted from the cache is received.

By the way, in wireless communication, communication quality varies according to a distance between a transmitter and a receiver. In IEEE802.11, available maximum link speed varies according to quality, and communication at higher speed and with more favorable energy efficiency can be realized when the distance is short. In conventional communication based on CCN, if a terminal requests information accumulated in a cache, the access point transmits the information without taking into account efficiency of wireless communication. For example, even if the terminal is far from the access point and communication efficiency is not favorable, the access point transmits a response. There is therefore a problem that a communication period becomes longer, which results in increasing energy consumption of the terminal. Further, because the communication period becomes longer, a period during which other terminals sharing the same access point could perform communication is wasted, which causes a problem of decreasing system throughput.

### BRIEF DESCRIPTION OF THE DRAWINGS

FIG. 1 is a schematic diagram of a network according to a first embodiment.

FIG. 2 is a functional block diagram of an access point according to the first embodiment.

FIG. 3 is a schematic diagram of a modified example of the access point according to the first embodiment.

FIG. 4 is a schematic diagram of another modified example of the access point according to the first embodiment.

FIG. 5 is an operation flow diagram of the access point according to the first embodiment.

FIGS. 6A and 6B are diagrams illustrating an example of parameters measured at a wireless monitor.

FIG. 7 is a diagram illustrating one of methods in which an access point encourages a terminal to transmit a radio signal.

FIG. 8 is a diagram illustrating an operation flow of modified example 3 according to the first embodiment.

FIG. 9 is a diagram illustrating an operation flow of modified example 4 according to the first embodiment.

FIG. 10 is a configuration diagram of an access point according to a second embodiment.

FIG. 11 is an operation flow diagram of the access point according to the second embodiment.

FIG. 12 is a configuration diagram of an access point according to a third embodiment.

FIG. 13 is an operation flow diagram of the access point according to the third embodiment.

FIG. 14 is a diagram for explaining operation of storing information acquired according to an acquisition request from a terminal and information acquired through prefetch in association with each other.

FIG. 15 is a diagram illustrating information stored through the operation in FIG. 14.

FIG. 16 is a diagram illustrating a hardware configuration example of a communication device according to embodiments of the present invention.

### DETAILED DESCRIPTION

According to one embodiment, a communication device includes: a wireless communication interface to transmit and receive a radio signal; a wireless monitor to measure a state of a communication channel with a counterpart device based on a frame to be communicated with the counterpart device via the wireless communication interface; a communication state determiner to determine whether to transmit information pre-acquired for the counterpart device to the counterpart device based on the state of the communication channel; and a communicator to transmit the information to the counterpart device via the wireless communication interface according to a determined result of the communication state determiner.

Below, embodiments will be described with reference to the accompanying drawings. Each embodiment described below is an example, and the present invention does not necessarily have to be implemented in a form described in these embodiments. Further, the same reference numerals are assigned to the same components in the drawings, and the same explanation will be omitted as appropriate.

### First Embodiment

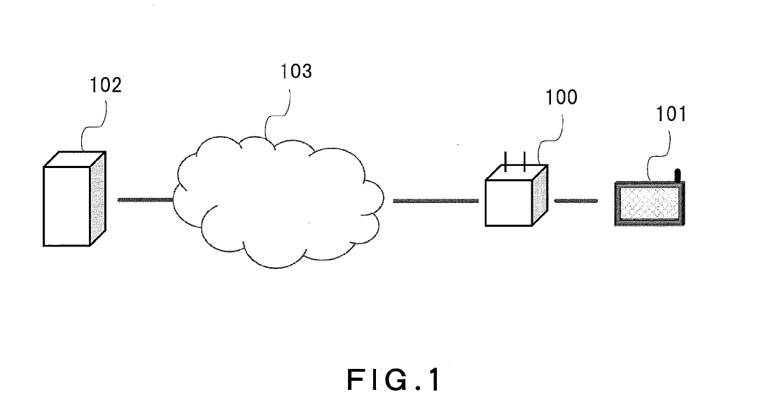

FIG. 1 is a schematic diagram of a network according to the first embodiment. A wireless communication terminal (hereinafter, referred to as a “terminal”) 101 is connected to a wireless access point (hereinafter, referred to as an “access point”) 100 via a wireless network. In the present embodiment, while it is assumed that communication according to a wireless communication scheme of IEEE802.11 standard is performed between the terminal 101 and the access point 100, the present embodiment can be applied to wireless communication schemes other than IEEE802.11 standard. The access point 100 is also connected to a network 103 at a backend side in a wired or wireless manner. A server 102 is connected to the network 103, and the terminal 101 communicates with the server 102 via the access point 100 and the network 103. The network 103 may be a wide area network such as Internet, or a local area network. Further, the network 103 may be a wired network, a wireless network or combination of a wired network and a wireless network.

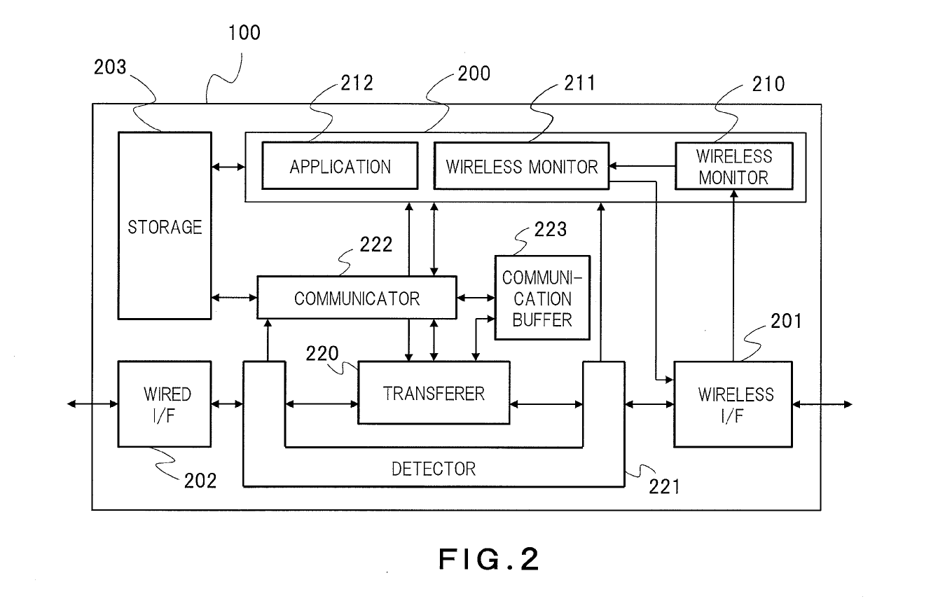

FIG. 2 is a functional block diagram of the access point 100. The access point 100 roughly includes a processor 200 administering the whole operation of the access point 100, a wireless I/F (interface) 201 connecting to a wireless network, a wired I/F 202 connecting to a wired network, a storage 203 to be utilized by application, or the like, running on the processor 200, and functional blocks (a transferer 220, a detector 221, a communicator 222 and a communication buffer 223) relating to communication processing.

The wireless I/F (interface) 201 performs protocol processing in a physical layer and a data link layer according to a wireless communication scheme (here, assuming IEEE802.11) to be used. Processing in the physical layer includes processing of a physical header, coding/decoding, modulation/demodulation, or the like. When the wireless I/F (interface) 201 includes a plurality of antennas and supports beam forming or MIMO, the processing in the physical layer may include processing for beam forming or MIMO. Processing in the data link layer includes processing of a data link layer header, error correction (or error detection), management of a communication link with a terminal (including transmission of a beacon frame), access control to a wireless medium (such as acquisition of access right (TXOP) based on backoff algorithm, and acquisition of access right (TXOP) through exchange of an RTS frame and a CTS frame). The wireless I/F (interface) 201 includes circuits such as a DA converter to convert a digital physical packet into analog and radiate the packet in a form of a radio signal (a signal of a radio wave), a bandpass filter, a mixer, an oscillator and an amplifier. Further, the wireless I/F (interface) 201 includes circuits such as a low noise amplifier, a mixer, an oscillator, a bandpass filter and an AD converter to acquire a digital physical packet from a wireless signal (a radio signal) received via an antenna. With the above-described configuration, the wireless I/F (interface) 201 generates a frame according to an instruction from a communication state determiner 211 which will be described later and transmits the frame to the terminal via (one or a plurality of) antennas or generates a frame for transmission from a packet or a frame inputted from the transferer 220 via the detector 221 and transmits the generated frame (more specifically, a physical packet including the frame) to the terminal. Further, the wireless I/F (interface) 201 outputs a frame correctly received from the terminal to the detector 221 or acquires information required for calculating a parameter relating to a state of a wireless communication channel at a wireless monitor 210 based on a frame to be transmitted or received and outputs the information to the wireless monitor 210. The wireless I/F (interface) 201 may acquire the information required for calculating the parameter according to a request from the wireless monitor 210, periodically or through an arbitrary event.

The wired I/F (interface) 202 performs protocol processing in a physical layer and a data link layer according to a communication scheme to be used. For example, when the wired I/F (interface) 202 is connected to an Ethernet (registered trademark), the wired I/F (interface) 202 performs processing in a physical layer and a data link layer relating to the Ethernet.

The processor 200 includes the wireless monitor 210, the communication state determiner (AP processor) 211, and application (application executor) 212. Each unit may be implemented as a dedicated functional block or as software running on the processor 200 which is used as a general-purpose processor. The wireless monitor 210 monitors a parameter which can be detected based on a frame communicated via the wireless I/F 201. The parameter which is a parameter characterizing a state of a wireless communication channel with a terminal which becomes a communication party, includes, for example, received radio signal intensity, an SNR (Signal Noise Rate), a frame error rate, the number of lost frames, and the number of times of frame retransmission. Some parameters are managed for each communication party (terminal), and other parameters are managed over the whole wireless network. It is also possible to manage the same parameter using the both methods and use the method according to the purpose of use. It is also possible to acquire a parameter which can be detected at the wireless I/F at the terminal side from the terminal and manage the parameter at the wireless monitor 210 of the access point. The parameter acquired from the terminal at this time may be the same as the parameter which can be detected at the wireless I/F 201 of the access point or may include different parameters. For example, a parameter such as the number of times a beacon transmitted from the access point cannot be received may be included. It is also possible to utilize a parameter measured at the terminal in place of the parameter measured at the access point.

The communication state determiner 211 executes various kinds of AP processing (such as, for example, association and authentication) to operate as a wireless LAN access point. Further, the communication state determiner 211 determines a state of a communication channel (communication state) with the terminal based on the parameter measured at the wireless monitor 210 and controls transmission operation to the terminal according to the determination result. The parameter itself measured at the wireless monitor 210 may be evaluated as the state of the communication channel (communication state), or the state of the communication channel (communication state) may be evaluated in a comprehensive manner from a plurality of parameters measured at the wireless monitor 210. For example, an evaluation value may be calculated by determining the plurality of parameters in a comprehensive manner (for example, using a function of outputting an evaluation value using the plurality of parameters as input), and used as the state of the communication channel (communication state). Alternatively, a rank may be calculated from the plurality of parameters and used as the state of the communication channel. The application 212 is management application for setting operation of the access point. While only one type of application 212 is illustrated in FIG. 2, a plurality of types of application may operate.

The transferer 220 transfers a frame in the data link layer (such as a MAC frame) to be exchanged between the wireless I/F 201 and the wired I/F 202 in both directions. The detector 221 scans a frame in the data link layer passing through the both I/F (for example, analyzes at least one of a frame header, a packet header and a segment header, or analyzes at least one of body portions of a frame, a packet and a segment), detects a frame to be processed at the access point 100 and passes the frame to the processor 200 or the communicator 222.

The communicator 222 performs communication using a communication protocol in a higher layer than the data link layer, for example, communication in a network layer or a transport layer (here, TCP/IP communication). In addition, the communication protocol may include an application layer protocol (for example, HTTP or DNS). The application layer protocol may operate at the processor 200, or may operate at both the processor 200 and the communicator 222 (the units may be used differently for each protocol or the units may cooperate with each other for one protocol). Further, the communicator 222 is also a portion where the access point 100 initiatively processes communication. For example, remote management communication for changing setting of the access point 100 corresponds to this portion.

The communication buffer 223 is a buffer used by the transferer 220 and the communicator 222. The communication buffer 223 stores a data link layer frame, stores a TCP/IP packet, or stores application data according to the purpose of use of the units. The communication buffer 223 may be a volatile memory such as a DRAM and an SRAM, a non-volatile memory such as a NAND type flash memory and an MRAM, or other recording media.

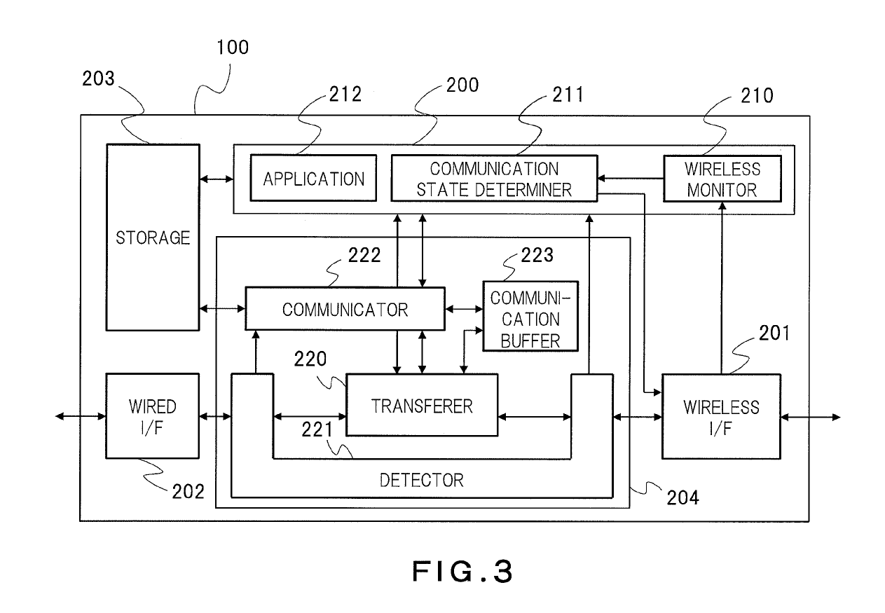

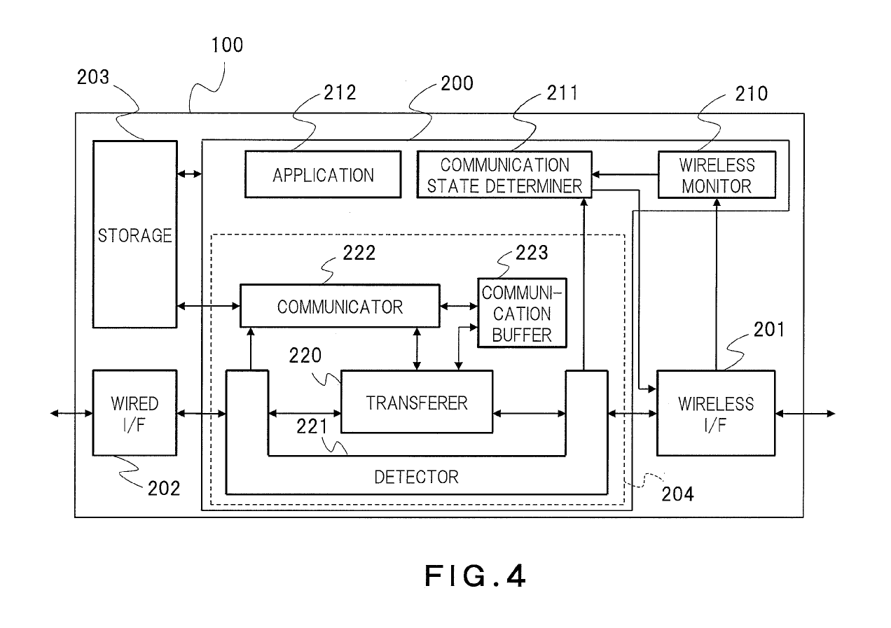

The configuration in FIG. 2 may be changed as illustrated in FIG. 3 or FIG. 4. FIG. 3 illustrates a case where portions relating to communication processing are collectively configured as a communication processor 204. The communication processor 204 includes functional blocks 220 to 223 illustrated in FIG. 2 inside. FIG. 4 illustrates a case where the portions including the communication processor 204 (for example, as an SoC) is configured inside the processor 200. In this case, operation of the communication processor 204 may not only include operation as a dedicated circuit within the processor 200, but also may be configured in combination with software. For example, the communication buffer may be configured with hardware such as a DRAM, and other units may be configured with software.

The present embodiment can be applied in a similar manner to any configuration illustrated in FIG. 2 to FIG. 4. Therefore, the following description will be provided assuming the configuration of FIG. 2.

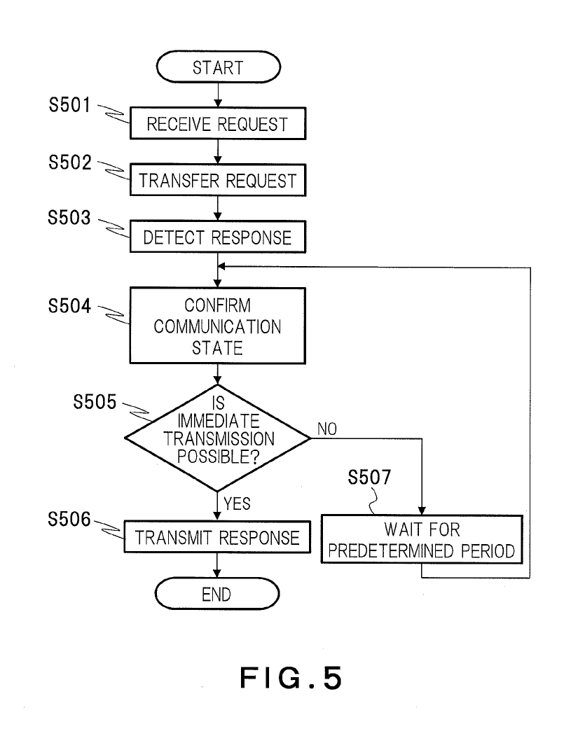

FIG. 5 illustrates an operation flow of the access point 100 according to the first embodiment. Operation of this flow is started by the terminal 101 connected to the wireless network transmitting an acquisition request of information to the server 102. The acquisition request such as “HTTP GET” in the case of HTTP, for example, is transmitted from the terminal 101 using a packet. While expression of transmitting or receiving an acquisition request of information and transmitting or receiving a response will be used in the following description, the request or the response is actually transmitted or received using a packet according to a communication protocol (such as TCP/IP) used. Of course, while a packet is formed into a frame through processing in the data link layer, further subjected to processing in the physical layer and transmitted as a physical packet, because transition from a packet to a frame and a physical packet is not essential in the present embodiment, the explanation thereof will be omitted.

The access point 100 receives the request transmitted from the terminal at the wireless I/F 201 (S501), and transfers the request to the server 102 via the wired I/F 202 (S502). When the server 102 returns a response including information requested by the terminal, the access point 100 detects the response at the detector 221 (S503). The detected response is temporarily stored in the communication buffer 223 via the transferer 220. At this time, the access point 100 may detect the response by responding to the request or may detect the response based on only a condition to be satisfied by the response regardless of the request. More specifically, while the former checks an IP address, a TCP port number (a TCP sequence number as necessary), or the like, of transmission and reception and confirms that communication is the same communication, the latter performs determination only according to whether or not a transmission destination TCP port number matches specific service (No. 80 in the case of a typical web access). In the present embodiment, because the response may be detected using any method, details will be not be described here.

The detector 221 informs to the processor 200 that the response is stored, and the communication state determiner 211 performs processing of confirming a state of a communication channel with a terminal which becomes a transmission destination of a response (S504). This processing will be described in detail later. The communication state determiner 211 determines whether the response can be transmitted to the terminal (whether the response can be transmitted immediately) based on the state of the communication channel. More specifically, the communication state determiner 211 performs determination according to whether or not the state of the communication channel satisfies a predetermined condition, and, if the state satisfies the predetermined condition, determines that the communication state is favorable and the response can be transmitted, and, if the state does not satisfy the predetermined condition, determines that the communication state is not favorable and the response cannot be transmitted.

For example, when a value of the communication state is expressed with an actual value, transmission may be allowed on the condition that the value is greater than a threshold or the value falls within a predetermined range. Transmission may be allowed on the condition that the value of the communication state is greater than a threshold or falls within a predetermined range for a predetermined period of time or longer. When the communication state is expressed with a rank, transmission may be allowed on the condition that the rank is equal to or higher than a predetermined rank. The examples described here are merely examples, and any condition may be used as long as it can be determined whether or not efficient transmission is possible based on the state of the communication channel. For example, a condition such as a threshold may be changed according to types of data (such as text and an image) to be communicated.

When it is determined that the response can be transmitted immediately (S505: Yes), the communication state determiner 211 issues an instruction to the transferer 220, and the transferer 220 transmits a response temporarily stored in the communication buffer 223 to the terminal via the wireless I/F 201 (S506). When it is determined that the response should not be transmitted to the terminal (S505: No), the communication state determiner 211 confirms the state of the communication channel again (S504) after waiting for a predetermined period (S507). This is repeated until it is determined that transmission is possible.

While the description of FIG. 5 is provided assuming that the terminal 101 starts communication (transmits a request) as basic operation, the present embodiment can be also applied in a similar manner when the terminal 101 at the wireless network side waits for communication. In this case, the access point 100 only has to detect a frame addressed to the terminal 101 being connected regardless of whether or not there is a request from the terminal 101.

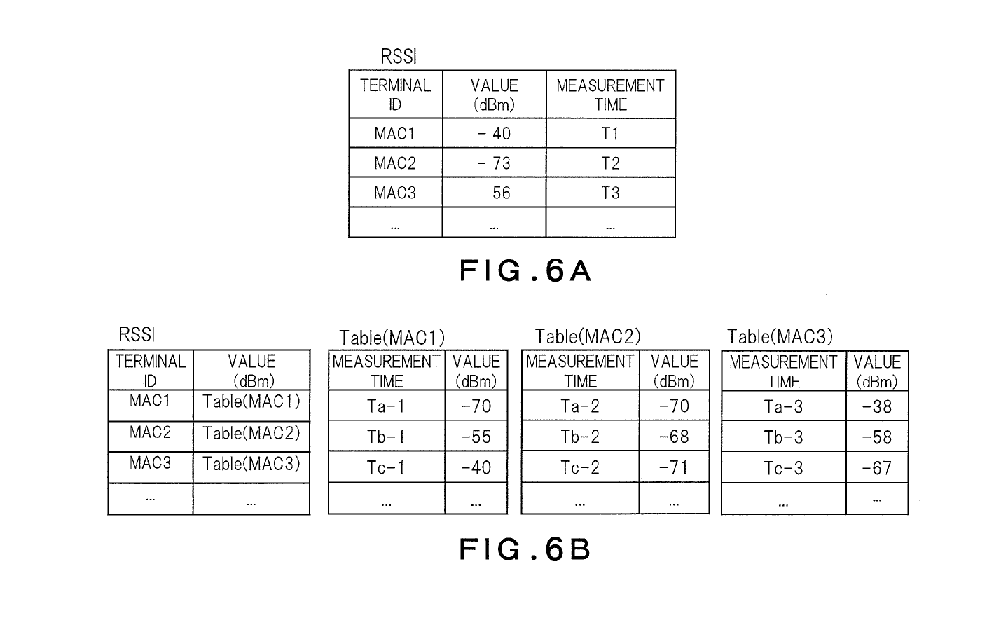

Communication state confirming processing (S504) in the operation flow in FIG. 5 will be described in detail. This processing is processing for confirming the state of the wireless communication channel with the terminal, and uses a parameter characterizing the state of the wireless communication channel, such as an RSSI and an SNR. The wireless monitor 210 calculates a parameter indicating the state of the communication channel (communication state) based on information obtained from a radio signal which can be continuously received via an antenna of the wireless I/F 201 and stores the parameter. When the wireless monitor 210 receives a request from the communication state determiner 211, the wireless monitor 210 determines whether or not the state of the communication channel for the terminal satisfies the condition set in advance and returns the result. Alternatively, the communication state determiner 211 receives a parameter from the wireless monitor 210 and determines whether the state of the communication channel for the terminal satisfies the condition set in advance. To realize this, measured parameter information is recorded in the storage 203, or the like, in a form as illustrated in FIG. 6A. In the example of FIG. 6A, an RSSI and the latest measurement time are recoded for each terminal.

As illustrated in FIG. 6B which will be described later, in addition to the latest RSSI, past RSSIs measured a plurality of times and the respective measurement times may be recorded. While FIG. 6A illustrates an RSSI as an example of the parameter, other parameters (such as an SNR and a frame loss rate) can be recorded in a similar manner.

Further, because a value of an RSSI varies from moment to moment for each terminal, it is necessary to sufficiently receive a radio signal from a target terminal. Here, “sufficiently” includes not only quantity sufficient for determination but also freshness of information, because it is impossible to appropriately confirm the state if old information is referred to. If information is not sufficient (when there is no entry in information as illustrated in FIG. 6A or when a predetermined period of time has elapsed since the communication state was measured last), it is also possible to encourage the terminal to transmit a radio signal.

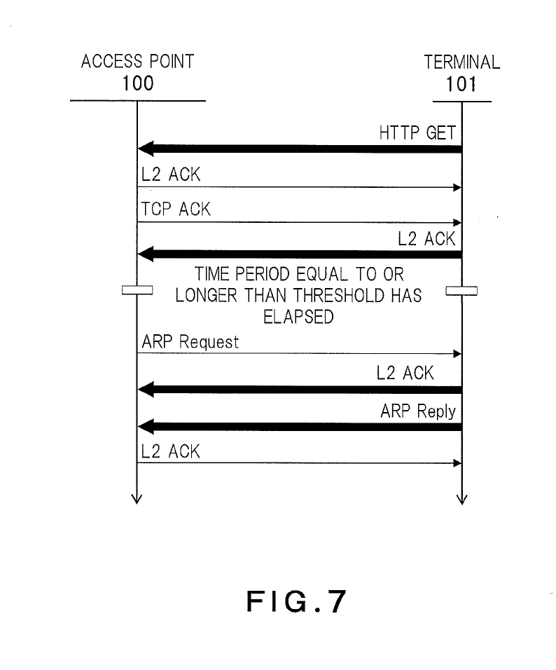

FIG. 7 illustrates one of methods in which the access point 100 encourages the terminal 101 to transmit a radio signal. This figure is a sequence illustrating exchange between the access point 100 and the terminal 101. In the figure, two types of lines with arrow are used (in a horizontal direction). A thick line indicates transmission of a frame from the terminal 101 to the access point 100, while a thin line indicates transmission of a frame from the access point 100 to the terminal 101. In the light of the operation of the access point 100, at least two frames (in this example, “HTTP GET” and “L2 ACK” where L2 is abbreviation of layer 2) are received from the terminal 101 in association with reception of the first request from the terminal 101. The wireless monitor 210 measures (for example) respective RSSIs based on these two frames and updates an entry corresponding to the information illustrated in FIG. 6A. For example, the wireless monitor 210 may update the entry using the RSSI measured at the first frame and update the entry again using the RSSI measured at the second frame. Alternatively, the wireless monitor 210 may update the entry using an average of the RSSIs of these two frames.

Here, when a request is not transmitted from the terminal to the access point 100 for a predetermined period of time or longer, the information obtained from the above two frames becomes old. Therefore, for example, as illustrated in FIG. 7, the access point 100 transmits “ARP Request” to the terminal 101. “ARP Request” is a frame to inquire from an IP address about a MAC address corresponding to it. When “ARP Request” is transmitted, the terminal 101 returns “L2 ACK (an ACK frame of a wireless LAN)” and “ARP Reply” in response to the “ARP Request”. The access point 100 only has to update the corresponding entry in the information in FIG. 6A using the information obtained through reception of these two frames.

“ARP Request” is an example of a trigger frame for encouraging the terminal to transmit a response frame, and the trigger frame is not limited to “ARP Request”. The trigger frame may be a frame or a packet with a short length which does not adversely affect the terminal 101 side. For example, it is possible to use a method in which “TCP ACK”, or the like, is transmitted and “L2 ACK” is received. However, “ACK” which involves a parameter which is likely to affect TCP communication being used should be avoided. For example, when the same ACK number is transmitted three times, because it is determined as a packet loss, and retransmission of a packet (segment) after the packet is determined as the packet loss is started, it is preferable to transmit the same ACK number up to twice. When “TCP ACK” is used, there is no influence if “TCP ACK” is transmitted using a method specified in “TCP Keep-Alive”. “ARP Request” is an example of a frame for inquiring about detailed information (here, an MAC address) of the terminal 101, and the same advantages can be also obtained using “IPv6 Neighbor Solicitation”. However, because a packet length of “IPv6 Neighbor Solicitation” is longer than that of “ARP”, “ARP” is more preferable.

Further, it is also possible to transmit a packet (such as a PING packet and a Traceroute packet) for verifying connectivity as another example of the trigger frame for encouraging the terminal to transmit a response frame.

Further, it is possible to use a method in which an IP packet for which a response is unlikely to be obtained from the terminal (for example, when a TCP SYN packet is transmitted to a random port to the terminal, in which case TCP is highly likely to be discarded at a personal firewall at the terminal side, so that the response cannot be obtained) or a meaningless L2 frame is transmitted. In both cases, if the frame is normally received, “L2 ACK” is expected to be received. However, if a method through which responses other than a delivery confirmation response can be obtained is selected, it can be considered that opportunities of measurement increase, and accuracy is improved.

Meanwhile, there is a concern that energy consumption increases due to the terminal being forced to perform transmission a plurality of times. Therefore, it is also possible to select a packet/frame of an appropriate type according to intended accuracy of measurement. For example, for a terminal which is detected for the first time (which can be supported on the assumption that information of a MAC address of a terminal connected in the past and a MAC address for which special processing is performed in advance are registered in the access point), there is a possible method in which each of “ARP”, “TCP ACK” and “Neighbor Discovery” is tried to confirm a frame which can be supported by the terminal. In a similar manner to this, for a terminal which has been supported in the past and a terminal for which setting is completed, it is only necessary to transmit a frame using a method limited to the method which could be utilized in the past. This can be achieved by providing a database managing an identifier of the terminal (which may be a MAC address, an association ID assigned upon association or other IDs) and a type of frame which could be used in combination in the access point. Alternatively, it is also possible to manage them at a management server provided outside the access point.

In this case, the management database only has to have information such as a used frame and a communication amount as additional items in a table as illustrated in FIG. 6A or FIG. 6B which will be described later.

Further, it is also possible to change frequency of measurement (reduces the number of times of measurement or extends an interval when communication frequency is low or a communication amount is small and increases the number of times of measurement or decreases an interval when the communication frequency is high and the communication amount is large) according to frequency or an amount of communication performed in the past or communication being currently executed and a type of information to be exchanged (whether or not communication is real time communication, whether or not a large size of data such as a moving image is transmitted and received in the case of non-real time communication).

It should be noted that when the wireless communication scheme applied between the access point and the terminal employs a NACK response scheme in which a response is returned when data cannot be normally received, it is also possible to perform measurement by utilizing a NACK response frame from the terminal. Further, when an RTS frame, a CTS frame, or the like, other than a frame relating to a delivery confirmation response such as an ACK response and a NACK response, is transmitted or received in a series of procedure for acquiring access right, it is, of course, possible to use a method in which the RTS frame or the CTS frame is utilized to perform measurement.

Still further, when the access point 100 and the terminal 101 supports beam forming, another method can be selected. More specifically, a method can be selected in which the state of the communication channel is measured during explicit confirmation procedure of a position of the terminal used for implementing beam forming.

In this method, the access point 100 transmits a frame for confirming a radio signal reception condition at the terminal, and the terminal receiving this frame transmits a frame for informing the reception condition (such as received power and received phase) to the access point. The access point 100 confirms a position, or the like, of the terminal based on the reception condition at the terminal informed using the frame. At this time, the access point 100 measures the state of the communication channel based on the frame which informs the reception condition. While this method requires to support an advanced wireless technique, because it is possible to recognize the state of the communication channel during normal operation sequence, it is not necessary to additionally transmit or receive a packet or a frame which is originally not required.

### MODIFIED EXAMPLE 1

### Determination Using a Plurality of Times of Measurement, Introduction of a Variation Rate

In the communication state confirming processing performed in step S504 of FIG. 5, it is not limited to perform a measurement of the state of the communication channel (communication state) once for each processing, and measurement may be performed a plurality of times. For example, measurement of the communication state may be repeated while transmission of a response to the terminal is wafted. Further, the measurement result may be stored in chronological order. For example, as illustrated in FIG. 6B, the measurement result may be recorded in chronological order (here, measurement time is set at Ta-X<Tb-X<Tc-X).

In this figure, the measurement results for three terminals are recorded in chronological order. Table (MAC1) is a recording of the terminal whose ID is MAC1, and a value of an RSSI gradually increases. That is, it can be understood that a radio signal condition is improved. On the other hand, in Table (MAC2), an RSSI value variation is small, and a radio signal condition scarcely varies. In Table (MAC3), a value of an RSSI gradually decreases, and a radio signal condition worsens.

If there is a tendency of radio signal intensity being improved or degrading through a plurality of times of measurement, it is also possible to perform adjustment so that variation can be detected immediately by increasing frequency of measurement. Adversely, if variation is small, frequency of measurement may be decreased. The frequency of measurement may be determined at the access point alone, or may be informed from the terminal side (in the latter case, a parameter is also measured at the terminal in a similar manner to the access point, and the frequency of measurement may be determined based on the parameter). When the terminal informs the frequency of measurement, the terminal may add information indicating a state of the terminal, such as values of an accelerator sensor and a magnetic sensor. It is also possible to estimate moving speed of the terminal by utilizing the value of the accelerator sensor and adjust the frequency of measurement informed from the terminal. For example, it is also possible to increase the frequency of measurement for higher moving speed. Further, the frequency of measurement and the value of the sensor may be informed when there is a predetermined variation in the sensors of the terminal, for example, when the value of the accelerator sensor varies by a predetermined value or a predetermined rate or higher. The access point side may adjust (for example, shorten) a measurement interval when receiving the frequency of measurement and the value of the sensor. It should be noted that waiting time in step S507 in FIG. 5 may be adjusted in a similar manner according to a plurality of times of measurement. Further, when a parameter is continuously measured regardless of the flow in FIG. 5, it is also possible to determine an interval of measurement to be performed in a similar manner based on results of measurement continuously performed.

Further, when a communication state variation is obtained from the results of a plurality of times of measurement, a variation rate of the communication state may be obtained. The plurality of times of measurement described here may be a case where a plurality of times of measurement is performed in step S504, or a case where processing of step S504 is repeatedly performed across waiting in step S507, or may include the both cases. By obtaining the variation rate, it is possible to determine whether or not immediate response is required. That is, when the variation rate is great, it can be considered that the terminal moves quickly, and when the variation rate is small, it can be considered that the terminal moves slowly or does not move. If the communication state is improved although the variation rate is small, it takes long time if processing is waited until a condition for immediate transmission in step S505 are satisfied (for example, a threshold is exceeded), which may increase waiting time of the user.

To address this, the waiting time in step S507 may be adjusted (for example, shortened) taking into account the variation rate.

### MODIFIED EXAMPLE 2

### When Communication State Worsens, Transmission is Performed Immediately

When a plurality of times of waiting is repeated in the operation flow in FIG. 5, there is a possibility that degradation of the communication state may be detected. In this case, because there is a risk that communication cannot be performed with the terminal, even if the communication state does not satisfy a predetermined condition in step S505, it may be determined to transmit a packet or a frame stored in the communication buffer 223. It should be noted that because this change can be considered as change of a determination condition in step S505 in FIG. 5, this change does not affect the operation flow diagram.

### MODIFIED EXAMPLE 3

### When Communication State is Not Improved, Packet or Frame is Transmitted by Giving Up or Discarded

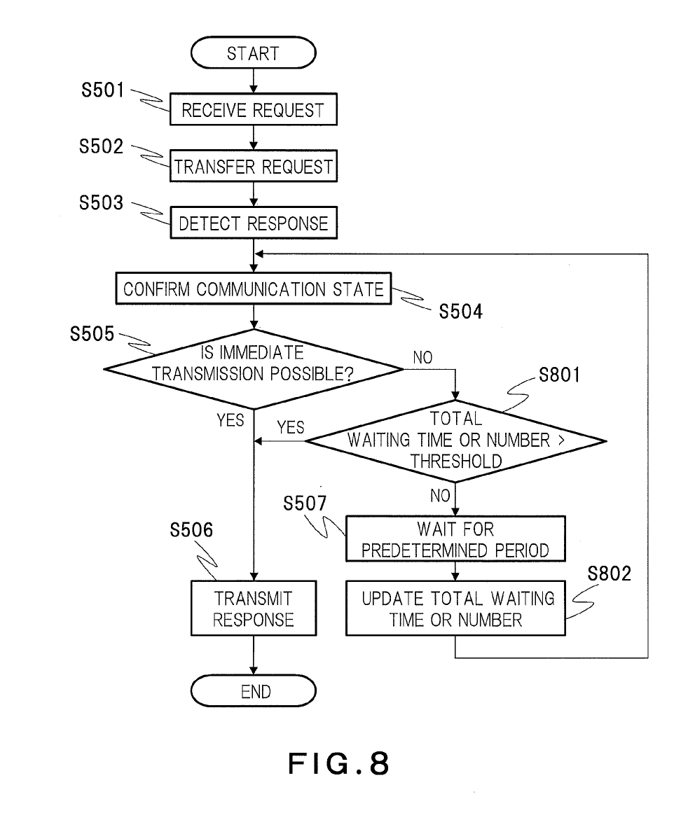

In the operation flow in FIG. 5 described above, when the communication state such as the radio signal condition is not improved, because the flow does not end and waiting and measurement are continued to be repeated, communication is not completed. Therefore, if the communication state is not improved even if a predetermined number of times of confirmation is performed or a predetermined period has elapsed, the packet or the frame stored in the communication buffer 223 may be transmitted to the terminal 101. Alternatively, the packet or the frame may be discarded without being transmitted to the terminal. The operation flow diagram to which this modification is added is illustrated in FIG. 8. In step S801, when it is determined that transmission cannot be performed immediately in step S505, either determination as to whether total waiting time exceeds a threshold or determination as to whether the total number of times of waiting exceeds a threshold, which is determined in advance, is performed. When the threshold is exceeded, the processing proceeds to step S506, and the packet or the frame in the communication buffer 223 is transmitted. On the other hand, if the threshold is not exceeded, it is waited for a predetermined period (S507), and either addition of a value of the waiting time to the total waiting time or incrementing of the total number of times of waiting by one, which is determined in advance, is performed, and the processing returns to step S504 in which the communication state is confirmed.

### MODIFIED EXAMPLE 4

### When Buffer Overflows, Packet or Frame is Transmitted by Giving Up or Discarded

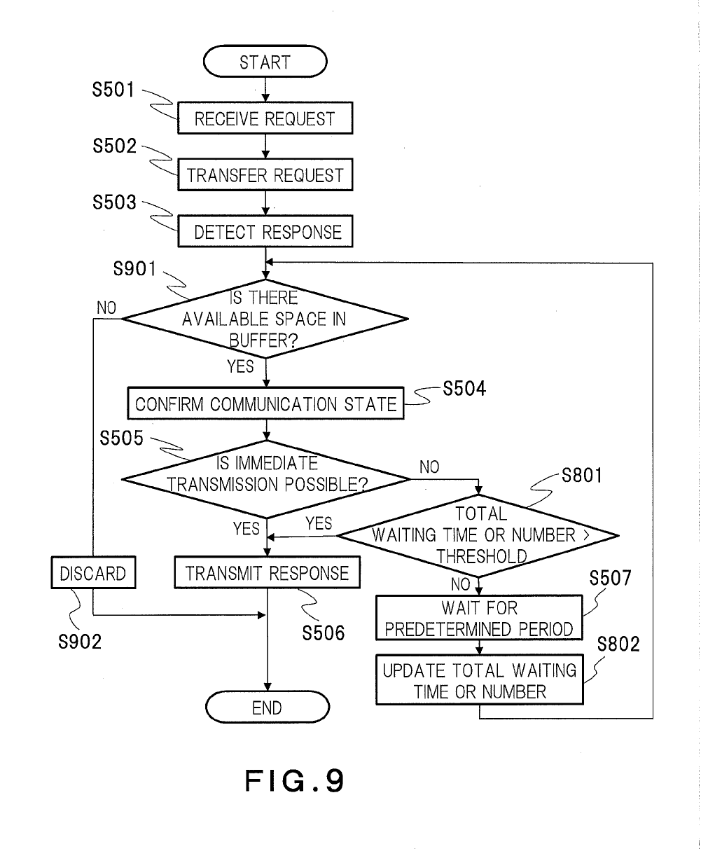

Because the communication buffer 223 is limited, if there are a number of terminals to which responses cannot be transmitted from the access point, there is a possibility that the buffer may overflow. In this case, packets or frames accumulated in the buffer may be transmitted to the terminal or discarded based on appropriate algorithm. The operation flow diagram obtained by adding this modification to FIG. 8 is illustrated in FIG. 9.

Steps S901 and S902 are added. After detection of a response in step S503, it is determined whether there is space for storing a response (a packet or a frame) in the communication buffer 223 (S901), and, if there is no space, a response (a packet or a frame) detected in step S503 is discarded. While, in the example of FIG. 9, a packet or a frame arriving later is discarded, the packet or the frame arriving later may be transmitted as is in advance of the packets or the frames buffered in the communication buffer 223. Alternatively, the processing may include a step of replacing content of the buffer when there is no buffer having space after it is confirmed whether or not there is a buffer having space in step S901. Replacing content of the buffer means that existing packets or frames are extracted from the buffer, the extracted packets or frames are temporarily evacuated, the packet or the frame arriving later is stored instead, and the evacuated packets or frames are transmitted or discarded.

### MODIFIED EXAMPLE 5

### Supplement for a Case Where Packet or Frame Cannot be Accumulated in Buffer

It should be noted that when a response (a packet or a frame) is buffered in the communication buffer 223 and transmission to the terminal is temporarily suspended, if “TCP ACK” is not transmitted to the server 102, there is a possibility that throughput substantially decreases because subsequent packets cannot arrive. In this case, the communicator 222 may generate “ACK” to the terminal on behalf and transmit the “ACK” to the server 102. However, because the terminal transmits “ACK” for communication which is responded on behalf, it is necessary to detect the “ACK” at the access point 100 and discard the “ACK”. The access point 100 requires to continue this processing (discarding of “ACK” from the terminal) until a sequence number included in the “ACK” from the terminal reaches a sequence number of “ACK” which is responded on behalf.

### Conclusion of First Embodiment

As described above, according to the present embodiment, because the communication state with the terminal is confirmed before transmission of a response, and transmission of the response is waited until the communication state becomes suitable for transmission, it is possible to transmit a response at a timing at which communication efficiency becomes favorable. By this means, it is possible to improve a period required for transmitting and receiving the response and energy efficiency, so that it is possible to improve throughput of the whole system.

### Second Embodiment

The second embodiment will be described next. The second embodiment is an embodiment in which a cache function is added to the access point in the first embodiment. The cache function is a function of temporarily storing information requested from the terminal, and, when the same information is requested again, providing the stored information to the terminal. The cache function is widely different from the communication buffer 223 in that the stored information is reused.

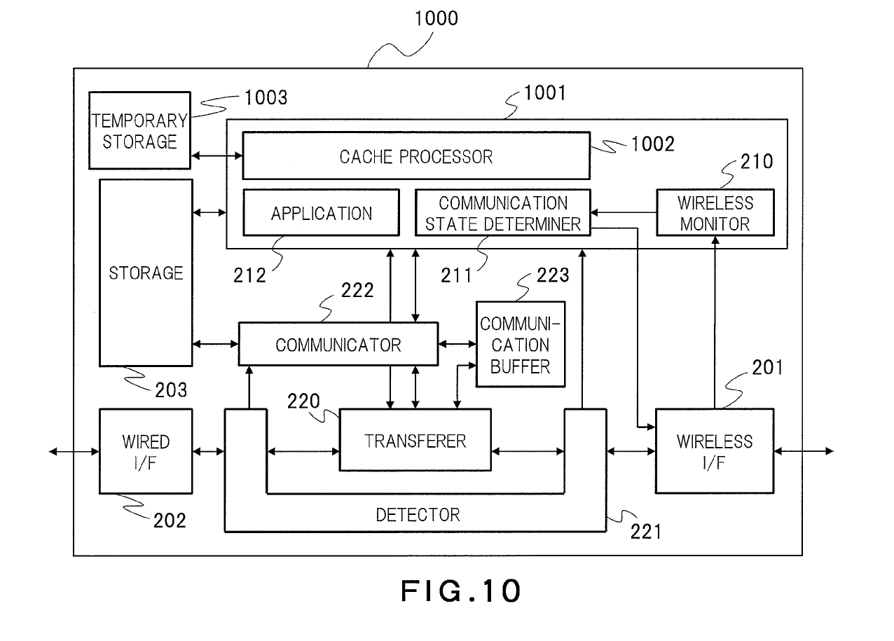

FIG. 10 illustrates a configuration diagram of an access point according to the second embodiment. A cache processor 1002 and a temporary storage 1003 are added to the access point in the first embodiment (in accordance with this, reference numerals are changed so that “1000” is assigned to the whole access point and “1001” is assigned to the processor). It should be noted that while it can be considered that the cache processor 1002 is part of the application 212, the cache processor 1002 is illustrated as an independent element here.

The temporary storage 1003 is a cache which temporarily stores information. The temporary storage 1003 may be a volatile memory such as a DRAM and an SRAM, a non-volatile memory such as a NAND type flash memory and an MRAM, or other recording media.

When the cache processor 1002 receives an acquisition request of information (for example, including an information identifier such as a URL as an acquisition destination) from the terminal 101, the cache processor 1002 confirms whether the information is stored in the temporary storage (cache) 1003, and, if the information is stored in the temporary storage 1003, reads out the information from the temporary storage 1003 and transmits the information to the terminal 101 via the communicator 222 and the wireless I/F 201 as a response. On the other hand, if the information is not stored in the temporary storage 1003, the cache processor 1002 acquires the information from the server 102 on behalf of the terminal 101. More specifically, the cache processor 1002 generates an acquisition request to the server 102 and transmits the request to the server 102 via the transferer 220 and the wired I/F 202 after the request is formed as a TCP/IP packet at the communicator 222. The server 102 processes the request received from the access point 100 and transmits a response including data of the requested information to the access point 1000. The cache processor 1002 stores the received response or data included in the received response in the temporary storage 1003 in association with information identifying the data (for example, an information identifier such as a URL included in the acquisition request from the terminal). The cache processor 1002 then transmits the information to the terminal 101 via the communicator 222 and the wireless I/F 201 as a response. Hereinafter, when receiving a request including the same information identifier from the terminal, the cache processor 1002 responds using the temporary storage 1003.

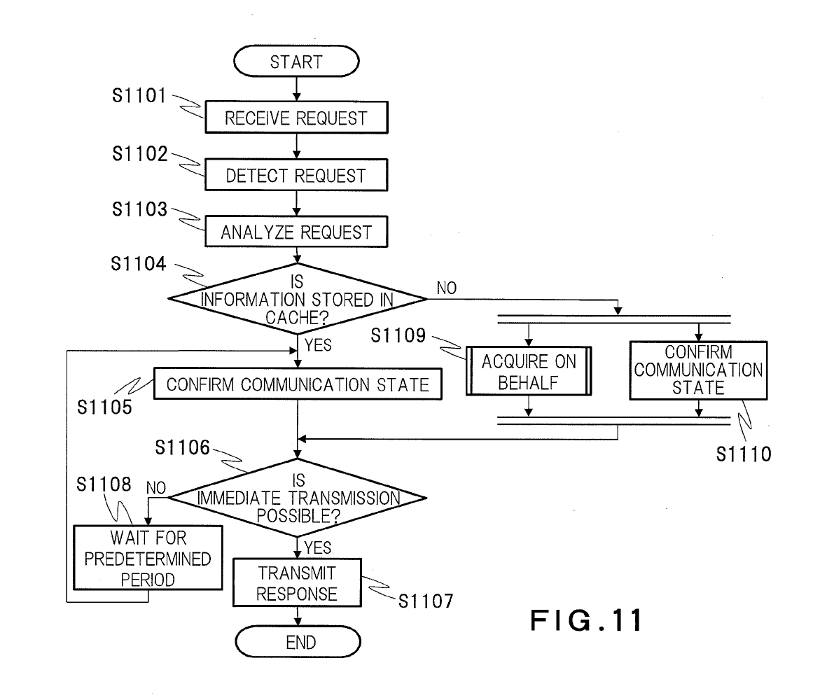

FIG. 11 illustrates an operation flow of the access point according to the second embodiment. This operation flow is a flow in which the operation flow in the first embodiment illustrated in FIG. 5 is expanded (It should be noted that different reference numerals are assigned to steps of the same processing as those in FIG. 5).

This operation flow is started by the terminal 101 transmitting an acquisition request to the server 102 and the access point 1000 receiving the request as in the first embodiment. However, the present embodiment is different from the first embodiment in that the access point 100 intercepts the request and processes the request. After the request from the terminal is received at the wireless I/F 201 (S1101), it is determined whether or not the packet is a packet to be intercepted at the detector 221. The packet to be intercepted is a packet including, for example, an acquisition request of information. A rule for detecting a packet to be intercepted is determined in advance. For example, a rule is set such that “a destination TCP port is No. 80” in the case of web access. The detector 221 detects a packet matching the rule set in advance and conveys the packet to the communicator 222. The communicator 222 performs processing of establishing TCP with the terminal 101 in place of the server which becomes an acquisition destination of the information, and, hereinafter, acts as if the terminal 101 communicated with the server. The communicator 222 extracts the acquisition request of the information from the intercepted packet and informs the request to the cache processor 1002 running at the processor 1001 (S1102).

When the cache processor 1002 confirms that the request informed from the communicator 222 is a request for acquiring information from the server 102 (S1103), the cache processor 1002 confirms whether the information to be acquired is stored in the temporary storage (cache) 1003 (S1104). If the information is stored in the temporary storage 1003 (S1104: Yes), the cache processor 1002 reads out the information from the temporary storage 1003 and transmits the information via the communicator 222 and the wireless I/F 201 as a response. More specifically, as in the first embodiment, the communication state determiner 211 confirms the communication state by utilizing the wireless monitor 210 (S1105), and determines whether the response can be transmitted immediately (S1106). If it is determined that the response can be transmitted immediately (S1106: Yes), the response is transmitted from the wireless I/F 201, and the processing ends (S1107). If it is determined that the response cannot be transmitted immediately (S1106: No), it is waited for a predetermined period (S1108), and the processing returns to processing for confirming the communication state (S1105). At this time, modifications such as change of waiting time according to the waiting time, the number of times of waiting and degradation of the communication state, change of an interval of measurement of the communication state, and immediate transmission of the response (even if a condition for immediate transmission are not satisfied) can be applied in a similar manner to each modified example of the first embodiment.

On the other hand, if the information to be acquired is not stored in the temporary storage 1003 (S1104: No), the access point 1000 transmits the acquisition request to the server 102 on behalf of the terminal 101 and acquires information (acquires information on behalf of the terminal 101) from the server 102 (S1109).

More specifically, the cache processor 1002 generates an acquisition request to the server 102 and transmits the request to the server 102 via the transferer 220 and the wired I/F 202 after the request is formed as a TCP/IP packet at the communicator 222. The server 102 processes the request from the access point 1000 and transmits a response including data of the requested information to the access point 1000. When the access point 1000 receives the response, the cache processor 1002 stores the response or data included in the response in the temporary storage 1003 along with information identifying the data (for example, a URL). Hereinafter, when a request having the same information identifier is received from the terminal, a response is transmitted using the temporary storage 1003.

In parallel with this processing of acquiring information on behalf of the terminal 101, processing of confirming a state of a communication channel (communication state) with the terminal 101 is performed using the wireless monitor 210 and the wireless I/F 201 (S1110). This processing is the same as the processing described in the first embodiment and step S1105. Because the processing of acquiring information on behalf of the terminal 101 (S1109) and processing of confirming the communication state (S1110) can be executed in parallel using different interfaces of the wired I/F 202 and the wireless I/F 201, it is described here that the processing is executed in parallel. However, the processing is not necessarily required to be executed in parallel, and, for example, when the processing is required to be sequentially executed from the view point of correctly recognizing latest information on the communication channel, the communication state may be recognized after information is acquired on behalf of the terminal 101. In either case, when the processing of acquiring information on behalf of the terminal 101 is completed, and the communication state can be confirmed, the processing shifts to processing of determining whether transmission can be performed immediately (S1106). Because the subsequent processing is as described above, the description will be omitted.

### Conclusion of Second Embodiment

As described above, in the present embodiment, when the access point 1000 has a cache function for temporarily storing information, and information requested from the terminal is stored in the cache, by transmitting a response using the cache, it is not necessary to access the server to acquire information, so that it is possible to realize immediate response. Further, because transmission delay is reduced, throughput for information acquisition is expected to be improved. Still further, it is not necessary to perform special operation as described in the supplement of the first embodiment, for example, generating “ACK” on behalf at the access point and transmitting “ACK” (Modified Example 5 in the first embodiment). While the present embodiment has been described in a manner that the operation flow of the first embodiment illustrated in FIG. 5 is expanded, it is also possible to expand the operation flow described in FIG. 8 or FIG. 9.

### Third Embodiment

The third embodiment will be described next. The third embodiment is characterized by addition of a prefetch function to the second embodiment. The prefetch function is a function of voluntarily acquiring information which is highly likely to be requested to be acquired from the terminal before receiving a request for acquiring information from the terminal and storing the information in the temporary storage (cache).

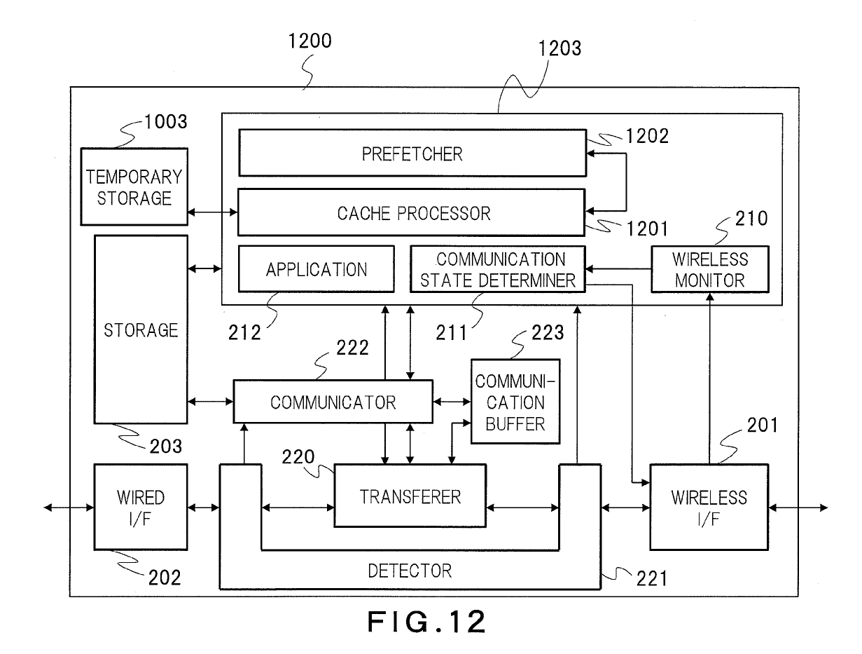

FIG. 12 illustrates a configuration diagram of an access point according to the third embodiment. In an access point 1200 of the present embodiment, a prefetcher 1202 is added to the second embodiment (in accordance with this, reference numerals are changed so that “1200” is assigned to the whole access point, “1203” is assigned to the processor, and “1202” is assigned to the prefetcher).

The prefetcher 1202 acquires information from a communication party such as a server based on (1) a request from the terminal, (2) average utilization tendency of the terminal recorded in a log, (3) access history of a terminal transmitting a request or a user of the terminal, (4) subscribed service, or the like, and caches the information in the temporary storage 1003. When information is acquired based on (1) the request from the terminal, the prefetcher 1202 acquires information directly requested from the terminal, and acquires information relating to the information requested from the terminal (such as, for example, information of a link destination of a URL when the URL is referred to in the information requested from the terminal). Acquisition of the latter information acquired based on (1) (information relating to the information requested from the terminal) and information of (2) to (4) is performed without a request to be acquired from the terminal, and corresponds to prefetch in the present embodiment. The prefetched information is information which is not requested to be acquired from the terminal, but is highly likely to be requested to be acquired from the terminal in the future.

The cache processor 1201 is a unit in which the cache processor 1002 in the second embodiment is expanded, and a function of coordinating with the prefetcher 1202 is added. Further, the cache processor 1201 has a function of extracting information requested from the terminal and information relating to the information from the temporary storage 1003 and collectively returning these information as a response to the terminal.

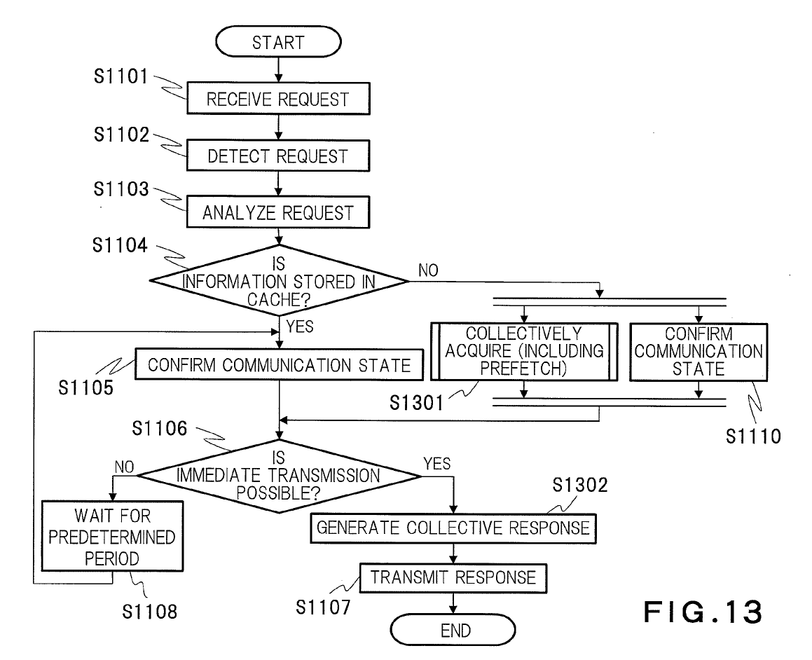

FIG. 13 illustrates an operation flow of the access point of the third embodiment. This operation flow is a flow in which part of the operation flow of the second embodiment illustrated in FIG. 11 is changed and expanded, and a step S1109 of acquiring information on behalf of the terminal 101 in FIG. 11 is changed to a step S1301 of collectively acquiring information, and after a step S1106 of determining whether transmission can be performed immediately, a step S1302 of generating a collective response is added.

In the processing of collectively acquiring information illustrated in step S1301, not only the information requested from the terminal is acquired, but also information relating to the requested information is acquired in advance (prefetched), and these information is accumulated in the temporary storage 1003 in association with the information requested from the terminal. In the processing of generating a collective response illustrated in step S1302, the cache processor 1201 extracts the information requested from the terminal and the information accumulated in association with the information requested from the terminal from the temporary storage 1003 and collectively transmits these information as a response.

### <Example of Processing of Collectively Acquiring Information (1)>

An example of the processing of collectively acquiring information executed in step S1301 will be described. When the cache processor 1201 receives an acquisition request of information and confirms that the information is not stored in the temporary storage 1003, the cache processor 1201 transfers the request to the prefetcher 1202. The prefetcher 1202 acquires information designated in the request and stores the information in the temporary storage 1003 via the cache processor 1201. Further, the prefetcher 1202 analyzes the acquired information, specifies information to be prefetched and acquires (prefetches) the specified information.

This will be described using a more specific example. It is assumed that the request transmitted from the terminal is expressed with the following URL.

http://www.example.com/index.html

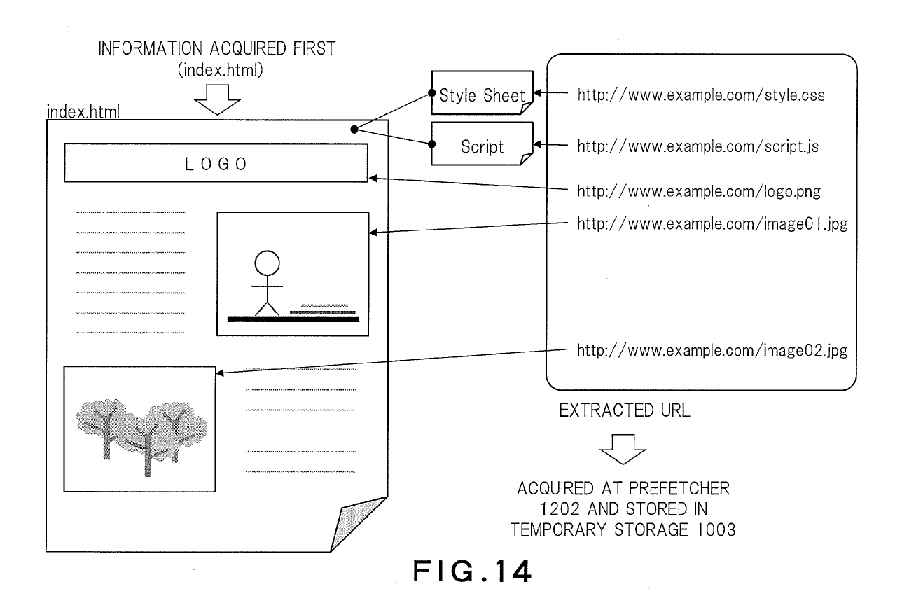

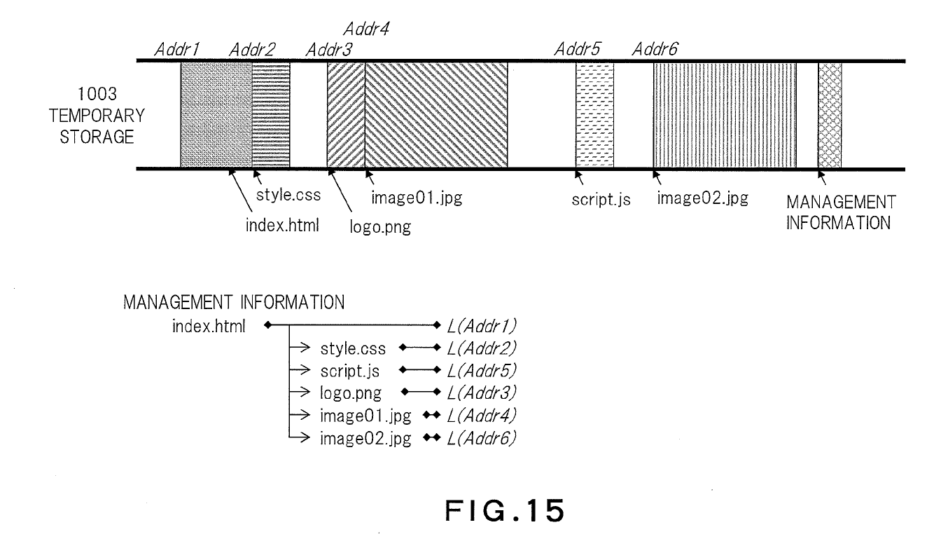

The prefetcher 1202 acquires a file specified by “index.html”, and stores the file in the temporary storage 1003. The prefetcher 1202 then analyzes “index.html” and extracts URLs of external files which are referred to (such as a script file, a style sheet and an image file). The prefetcher 1202 sequentially acquires the external files from these URLs and stores the files in the temporary storage 1003. At this time, the files are stored in association with information of “index.html” which is stored first, so that the information can be collectively read out as related information. A schematic diagram of the above-described operation is illustrated in FIG. 14. Further, a state of the information stored in the temporary storage 1003 is illustrated in FIG. 15.

In the example of FIG. 15, management information is stored along with a series of configuration files. In the management information, a relationship between the information requested from the terminal (in this example, “index.html”) and information referred to from the information is recorded. By storing this management information along with the information requested from the terminal, it is possible to collectively read out the requested information and the related information.

It should be noted that a unique address for specifying a location where information is stored is assigned in the temporary storage 1003. This address is an absolute position (physical position) handled in the temporary storage 1003. It should be noted that because software running on the processor 1203 handles the temporary storage 1003 via a file system, conversion between a logical position (or a file name) and the physical position is performed inside. Because the operation of the file system does not affect essence of the present embodiment, the explanation thereof will be omitted. In either case, in the management information, a physical address where information is finally stored or information (such as a file name) for obtaining the information is stored. While in the example of the management information illustrated in a lower part of FIG. 15, a file name and a logical address (such as L(addr1)) are recorded, it is, of course, possible to record only a file name.

When a plurality of types of application are running on the processor 1203 at the same time, there are a plurality of types of application for performing writing processing in the temporary storage 1003. In this case, files cannot be always sequentially acquired for each application. This also applies to a case where there is one type of application running on the processor 1203, in which case files cannot be always sequentially acquired. Therefore, the information requested to be acquired and the information relating to the information (prefetched information) are not always stored in one continuous region. For example, as in the example of FIG. 15, the information requested from the terminal and the prefetched information may be arranged while being distributed for each information. In the present embodiment, even if the information is arranged while being distributed, it is possible to appropriately read out the related information by referring to the management information.

Finally, the processing by the prefetcher 1202 ends when all the information requested first and information referred to from the information can be acquired. While the information referred to may be recursively acquired, it is assumed that its depth is set in advance. The “depth” indicates the number of times of repetition of reference when another HTML file is referred to from “index.html” requested first, and when other information is further referred to from the HTML file.

The depth (the number of times of repetition) may be set for various manners such as for each terminal, for each user who utilizes the terminal, for each network used for acquiring information (a destination IP address included in the request or a domain name), for each wireless network to be provided, or may be wholly set. The setting is not limited to fixed setting, and, for example, may change according to a time zone (for example, when the network has relatively space, the depth is set deep, while when the network is congested, the depth is set shallow), a day of the week, date, whether weekday or weekends, whether or not there is additional charging (for example, an additional fee is set for prefetch at a deep level), or the like.

When acquisition by the prefetcher 1202 is completed, the cache processor 1201 receives notification the effect thereof. The cache processor 1201 first reads out the information (file) requested from the terminal from the temporary storage 1003 and also reads out the management information. The prefetcher 1202 then sequentially reads out the related information (files) while referring to the management information. Subsequently, the prefetcher 1202 generates a response by organizing the read out information and transmits the response to the terminal via the communicator 222 and the wireless I/F 201.

Here, there are some possible methods for organizing a plurality of pieces of information as a response. First, there is a method in which individual files are simply coupled, and the coupled files including identification information and length information of each file are transmitted. Secondly, there is a method in which files are converted into a compressed file, such as a ZIP file, which is typically utilized, and transmitted as one file. Thirdly, there is a method in which a plurality of files are converted into a special form, and the files including a program for restoring the files are transmitted.

Fourth, there is a method in which requested “index.html” is transmitted first, and, then, files acquired by the prefetcher 1202 are continuously transmitted before a new request is received from the terminal. There are methods other than the methods described here. Any method can be employed for implementing the present invention as long as a plurality of pieces of information can be continuously transmitted to the terminal using some methods.

### <Example of Processing of Collectively Acquiring Information (2)>

In the example of the processing of collectively acquiring information (1) described above, the terminal further acquires information which is referred to from the information requested from the terminal, so that related information is acquired in advance and continuously and collectively transmitted to the terminal. As another method, as described above, related information may be acquired with reference to past access history (information acquisition history) recognized by the access point or a peripheral management device (management server), or the like. The past access state may be directed to the terminal which transmits the request or part or all of terminals which share some characteristics (for example, characteristics which do not depend on users, such as users having the same type of terminal, users subscribing the same service, or characteristics which depend on users, such as age and sex of the users). While, in the former case, information frequently accessed by a user of the terminal is accumulated in the temporary storage 1003 in advance, in the latter case, information popular with all the users is accumulated in the temporary storage 1003. This, for example, corresponds to a moving image or a news article which attracts attention. Access history of each terminal or user is recorded, and content to be prefetched and an execution timing are comprehensively determined from a day of the week, time, whether weekday or weekends, weather, location, a type of the terminal, attribute of a user (such as age, sex and occupation). This determination method can include various kinds of variations, and any method can be used as long as these pieces of information are utilized.

### <Adjustment of Transmission Timing of Collectively Transmitting Response>

With the method of the present embodiment described above, the terminal cannot receive a response until acquisition processing by the prefetcher 1202 (acquisition of information requested from the terminal and acquisition (prefetch) of information relating to the information) is completed after the terminal transmits an acquisition request of the information. This constraint is inconvenience for a user of the terminal. Therefore, an operation example in which the method is modified to address this problem will be described.

As illustrated in the flow diagram of FIG. 13, the processing of collectively acquiring information (S1301) of the prefetcher 1202 and the processing of confirming a communication state (S1110) of the communication state determiner 211 can be executed in parallel. Therefore, even when the prefetcher 1202 is running, the communication state determiner 211 can detect whether the state of the communication channel (communication state) varies, for example, whether the communication state of the terminal is improved, worsened, or does not vary.

When the communication state does not vary or is improved, because it is efficient if information is transmitted at a timing at which as much information as possible can be communicated at high speed, in principle, processing is performed so as to continue waiting. However, there is a case where maximum waiting time (or a maximum number of times of waiting) is determined according to application, setting of the terminal or setting of the access point, and, if the time or the number reaches the upper limit, a response may be returned without waiting (see FIG. 8).

Further, it is also possible to first transmit information requested first as a response using a method indicated in any of the first to the third embodiments, read out information obtained through prefetch from the temporary storage 1003 based on a method indicated in any of the first to the third embodiments in a stage where a request is received from the terminal, and collectively transmit the information (transmission of a response in two stages).

Further, when transmission of a response in two stages is performed, it is also possible to perform control so that part of information acquired through prefetch is included in the first response and the subsequent information is transmitted in the second response. In this case, it is only necessary to manage a URL for identifying the requested information and information as to which part of the information which should be collectively transmitted as a response (prefetched information) was transmitted in the temporary storage 1003 or the storage 203 for each terminal.

On the other hand, if the communication state worsens, there is a possibility that the communication state may further worsen or communication cannot be performed at worst by waiting. Therefore, when it is detected that the communication state worsens, even if the prefetcher 1202 is running, if at least information for the request from the terminal can be acquired, a completed portion may be immediately transmitted as a response.

It should be noted that when a response is transmitted using the method described here in the course of prefetch processing, the prefetcher 1202 informs completion of acquisition to the cache processor 1201 as operation.

However, after the completion of acquisition is informed, the prefetcher 1202 continues prefetch operation. By this means, when the same information is referred to from other terminals, it is possible to efficiently transmit a response by utilizing prefetched related information.

### <Determination as to Whether or Not Prefetch can be Executed, and Addition of Processing of Changing Depth to be Acquired>

While in the present embodiment, the prefetcher 1202 is added, there is a case where it is better not to execute prefetch depending on the communication state of the terminal, for example, in a case where the communication state is not favorable and a variation rate of the communication state is small. In this case, because the terminal is less likely to move, even if a large amount of information is prefetched, a large effect cannot be expected. Therefore, in such a condition, prefetch is not executed, or it is adjusted so that prefetch is performed at a relatively shallow level. An operation example of prefetch which can be applied according to the communication state variation, more specifically, combination of a direction of the variation and a size of a variation rate will be described below.

In the following description, the variation rate of the communication state is divided into two segments of “large” and “small”.

The direction of the communication state variation is divided in to three segments of “improved”, “worsened” and “no variation”. The variation rate of the communication state may be divided into “large” and “small” segments according to a degree of an absolute value of a difference or a ratio between, for example, a value of the latest communication state and a value of the last communication state, or may be divided into “large” and “small” segments according to a degree of an absolute value of slope of a line which approximates values of the communication states of three times or more, or may be divided using other methods.

Further, the variation rate of the communication state may be divided into three or more segments, for example, “extremely large”, “large”, “small” and “extremely small” instead of being divided into two segments of “large” and “small”. The direction of the the communication state variation may be classified into “improved” if, for example, a difference or a ratio between the value of the latest communication state and the value of the last communication state is greater than a first threshold, and classified into “no variation” if the difference or the ratio is equal to or smaller than the first threshold and greater than a second threshold, and classified into “worsened” if the difference or the ratio is equal to or less than the second threshold. Alternatively, it is also possible to specify segments of “improved”, “no variation” and “worsened” for respective differences or the ratios between temporally adjacent values of the communication states of three times or more and employ a segment with the largest number using a rule of majority, or determine the segment using methods other than the methods described here. As with the variation rate of the communication state, the number of segments is not limited to this example (here, three), and may be two, or four or more. It should be noted that “improved”, “worsened” and “no variation” are merely directions of communication state variation, and a value of an actual communication state (whether the communication state is favorable or not favorable) is different from the directions of the variation. That is, even if the direction of the variation is “worsened”, the communication state may be favorable (for example, the value of the communication state is greater than a threshold) or may be not favorable (for example, the value of the communication state is equal to or lower than the threshold).

While the variation rate and expression such as the communication state being improved or worsened are used in the first embodiment and the modified examples, and other embodiments, these may conform to the example described in this paragraph.

(Variation rate, communication state variation)=(large, improved)

Because it can be considered that the terminal rapidly approaches the access point and there is a possibility that the terminal moves to far if prefetch is performed for a long period of time (the terminal passes through the access point and moves away from the access point before prefetch is completed), an amount of information to be prefetched is made small (depth is made a shallow level). By this means, the terminal completes prefetch at a timing at which the terminal is close to the access point, so that it is possible to immediately transmit information requested by the terminal and the prefetched information (S1106). It should be noted that there are various kinds of variations as described above in forms of transmission of these pieces of information (the same will apply to the following).

(Variation rate, communication state variation)=(large, worsened)

Because it can be considered that the terminal rapidly moves away from the access point, prefetch is limited to acquisition of only a small part of information (the depth is made a shallow level), or prefetch is not performed, so that a response is immediately transmitted. In this case, it is also possible to transmit a response when a predetermined condition for immediate transmission (S1106) are satisfied, or as also described in the first embodiment, change operation so that transmission is performed even if the predetermined condition is not satisfied. The depth of prefetch may be determined based on the measured communication state. For example, the depth of prefetch may be set a deeper level when the communication state is more favorable. Further, the depth of prefetch may be made a shallow level when the communication state is worse.

(Variation rate, communication state variation)=(small, improved)

Because it can be considered that the terminal gradually approaches the access point, there is no problem in performing prefetch for a long period of time. That is, even if prefetch is performed for a long period of time, it is estimated that the terminal is located at a position close to the access point or approaches the access point when the prefetch is completed. It is therefore possible to execute prefetch so as to acquire as much information as possible (set the depth at a deep level). Actually, the depth is determined based on setting of the application while how the user feels is taken into account.

(Variation rate, communication state variation)=(small, no variation)

Because it can be considered that the terminal does not move far, if the communication state is not favorable, prefetch may not be performed, or only part of information may be prefetched (the depth is made shallow or small data such as text is prefetched). If the communication state is favorable, prefetch may be performed at a deep level. Alternatively, if the communication state is favorable, it may be determined not to perform prefetch because there is no problem of a communication period or energy consumption by the requested information being transmitted every time a request is received from the terminal.

(Variation rate, communication state variation)=(small, worsened)

Because it is expected that the terminal gradually moves away from the access point, if prefetch is executed, only part of information is prefetched (the depth is made shallow). Whether or not prefetch can be performed may be determined according to the value of the communication state. The depth of prefetch may be determined based on the measured communication state. For example, when the communication state is favorable, it can be expected that the terminal is located in an environment with a favorable communication state for a while, the depth of prefetch may be made a deep level. Meanwhile, when the communication state is not favorable, the depth of prefetch may be made a shallow level.

It should be noted that there are no condition that (variation rate, communication state variation)=(large, no variation).

It should be noted that determination based on combination of the direction of the communication state variation and a degree of the variation rate as described above does not have to be necessarily made coordinate with prefetch, and the determination can be applied to determination of at least one of waiting time and a measurement interval of a parameter in the first embodiment, or the like.

### Conclusion of Third Embodiment

As described above, in the present embodiment, because the access point has a cache function for temporarily storing information and a prefetch function for actively (voluntarily) acquiring information relating to the requested information, it is possible to effectively transmit information to the terminal. As a result, it is possible to further reduce energy consumption of the terminal, so that it is possible to improve throughput of the whole system.

While the first to the third embodiments have been described aimed at a wireless LAN, it is obvious that the present invention can be applied to wireless communication techniques other than the wireless LAN if there is a common phenomenon that communication efficiency varies when a distance between a transmission side and a reception side becomes larger. Further, while the method using a radio wave is described as a wireless medium, attenuation by a distance is not inherent in the radio wave. The present invention can be also applied to a communication scheme in which physical media such as a sound wave, a visible light and an infrared light are used and the communication speed varies.

While in the first to the third embodiments, a case has been described where the terminal requests acquisition of information to the access point, and the access point transmits the information to the terminal as a response, the embodiments of the present invention can be also applied to one terminal in the case where terminals directly perform communication with each other without intervening the access point. As a standard in which terminals perform communication with each other without intervening an access point, WiFi Direct, or the like, is known. When a function of a terminal supporting WiFi Direct is enabled, the terminal is recognized as an access point from other terminals, so that it is possible to realize one to one or one to multiple connections. In this case, the embodiments of the present invention can be applied to a terminal at a reception side of the acquisition request of the information. At this time, as a terminal configuration, a configuration can be used in which a wired I/F connected to a network at the backbone side and a transfer function (relay function) of the wired I/F and a wireless I/F are removed from the configuration of the access point. The terminal which receives the acquisition request of the information holds the information requested to be acquired in a storage inside or an externally connected storage in advance, and has a server function for transmitting information requested from a counterpart terminal. Upon transmission, by performing processing of determining whether or not information can be transmitted based on the state of the communication channel to the counterpart terminal, the operation of the present embodiment can be implemented.

It should be noted that the communication device (the access point or the terminal) according to each embodiment can be realized using, for example, a general-purpose computer device as basic hardware. That is, the communication device can be realized by causing a processor mounted on the above-described computer device to execute a program. At this time, the communication device can be realized by the above-described program being installed in advance in the computer device, or by the above-described program being stored in various kinds of storage media or distributed via a network, and installed in the computer device as appropriate. Further, each storage inside the communication device can be realized by utilizing storage media such as a memory, a hard disc or a CD-R, a CD-RW, a DVD-RAM or a DVD-R incorporated into or externally connected to the above-described computer device as appropriate. Further, an energy management device of the communication device can be configured with an LSI or a dedicated chip.

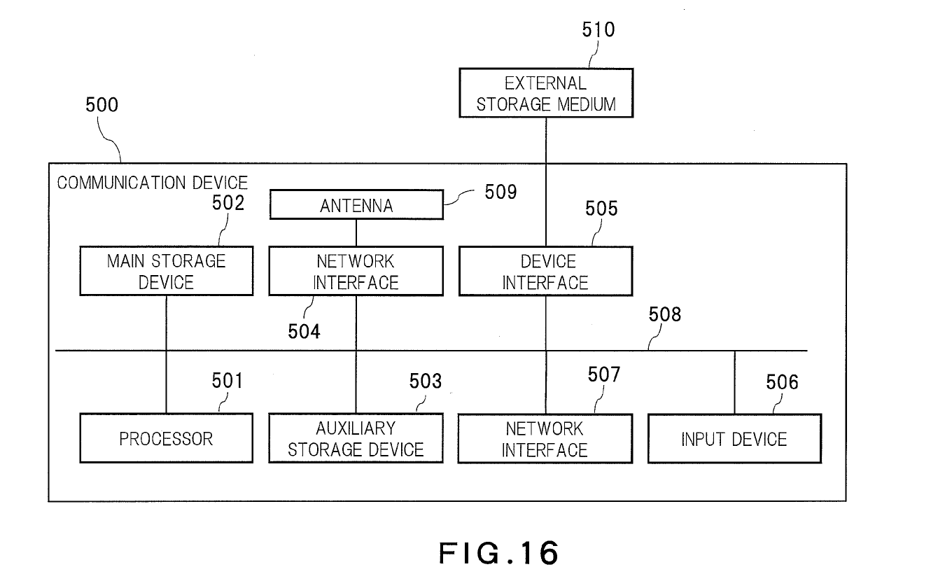

FIG. 16 illustrates a hardware configuration example of the communication device according to the embodiments of the present invention. Here, a configuration in a case where the communication device is implemented as the access point will be illustrated. When the communication device is implemented as the terminal, it is only necessary to remove or add functions according to a difference between the above-described access point and the terminal.

The communication terminal includes a processor 501, a main storage device 502, an auxiliary storage device 503, a network interface 504, a device interface 505, an input device 506, and a network interface 507, and can be implemented as a computer device in which these are connected via a bus 508.

By the processor 501 reading out a program from the auxiliary storage device 503, decompressing the program to the main storage device 502 and executing the program, each functional block can be realized.

The network interface 504 is an interface for connecting to a wireless network via an antenna 509, or the like. A function of the wireless I/F 201 can be realized at this network interface. The network interface 507 is an interface for connecting to a network at the backbone side in a wired manner. A function of the wired I/F 202 can be realized at this network interface 507.

Further, the device interface 505 is an interface for connecting to equipment such as an external storage medium 510. When the storage 203 is externally connected to the access point or connected to the access point via a network, the external storage medium 510 corresponds to the storage 203. The external storage medium 510 may be any arbitrary recording medium such as an HDD, a CD-R, a CD-RW, a DVD-RAM and a DVD-R.

The user may input information from the input device 506. The inputted information may be an instruction to application. It should be noted that a display device such as a liquid crystal display device for displaying information may be added to the communication device.

The main storage device 502 is a memory device which temporarily stores an instruction executed by the processor 501, various kinds of data, or the like, and may be a volatile memory such as a DRAM or a non-volatile memory such as an MRAM. The auxiliary storage device 503 is a storage device for permanently storing a program, data, or the like, and includes, for example, an HDD or an SSD. Functions of the storage 203 or the temporary storage 1003 may be implemented in at least any of the main storage device 502, the auxiliary storage device 503 or the external storage medium 510.

The terms used in each embodiment should be interpreted broadly. For example, the term “processor” may encompass a general purpose processor, a central processor (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, one or more microprocessors in conjunction with a DSP core.

As another example, the term “storage” or “storage device” employed in the embodiments, may encompass any electronic component which can store electronic information. The “storage” or “storage device” may refer to various types of media such as random access memory (RAM), read-only memory (ROM), programmable read-only memory (PROM), erasable programmable read only memory (EPROM), electrically erasable PROM (EEPROM), non-volatile random access memory (NVRAM), flash memory, magnetic such as an HDD, an optical disc or SSD.

It can be said that the storage electronically communicates with a processor if the processor read and/or write information for the storage. The storage may be integrated to a processor and also in this case, it can be said that the storage electronically communication with the processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication device comprising:
a wireless communication interface to transmit and receive a wireless signal;
a wireless monitor to measure a state of a communication channel with a counterpart device based on a frame to be communicated with the counterpart device via the wireless communication interface;
a communication state determiner to determine whether to transmit information pre-acquired for the counterpart device to the counterpart device based on the state of the communication channel; and
a communicator to transmit the information to the counterpart device via the wireless communication interface according to a determined result of the communication state determiner.

2. The communication device according to claim 1,
wherein the communicator receives an acquisition request of information from the counterpart device, communicates with an external device according to the acquisition request, acquires information requested in the acquisition request from the external device, and transmits an acquired information to the counterpart device when the communication state determiner determines to transmit the information to the counterpart device.

3. The communication device according to claim 1,
wherein the communication state determiner determines whether to transmit the information to the counterpart device based on a variation of the state of the communication channel.

4. The communication device according to claim 3,
wherein the communication state determiner determines whether to transmit the information to the counterpart device based on a degree of the variation of the state of the communication channel and a direction of the variation.

5. The communication device according to claim 1,
wherein the communication state determiner determines at least one of a frequency at which determination is made as to whether to transmit the information to the counterpart device and a frequency at which measurement of the state of the communication channel is performed by the wireless monitor, based on a variation of the state of the communication channel.

6. The communication device according to claim 5,
wherein the communication state determiner determines the frequency, based on a degree of variation of the state of the communication channel and a direction of the variation.

7. The communication device according to claim 1,
wherein the communication state determiner transmits a trigger frame via the wireless communication interface, the trigger frame encouraging the counterpart device to return a response frame, and
the wireless communication interface receives the response frame for the trigger frame, and the wireless monitor measures the state of the communication channel based on the response frame received at the wireless communication interface.

8. The communication device according to claim 7,
wherein the trigger frame is at least one of a frame inquiring detailed information of the counterpart device, a frame for verifying connectivity with the counterpart device, and a frame for confirming a reception condition of a radio wave at the counterpart device.

9. The communication device according to claim 7,
wherein the trigger frame is a frame encouraging to at least return a delivery confirmation response in a data link layer.

10. The communication device according to claim 1, further comprising:
a cache processor to receive an acquisition request of information from the counterpart device via the communicator, acquire the information from an external device via a network according to the acquisition request and to store the information in a storage,
wherein the cache processor confirms whether the information is stored in the storage when receiving the acquisition request of the information from the counterpart device, and
when the information is stored in the storage and the determiner determines to transmit the information to the counterpart device, the cache processor transmits the information stored in the storage to the counterpart device.

11. The communication device according to claim 10, further comprising:
a prefetcher, when receiving the acquisition request from the counterpart device, to specify first information which is information likely to be requested to be acquired from the counterpart device after the acquisition request is made and acquire the first information,
wherein the cache processor stores the first information in the storage in association with the information designated by the acquisition request,
the cache processor transmits the information designated by the acquisition request and the first information to the counterpart device, and
the cache processor controls at least one of determination as to whether acquisition of the first information by the prefetcher is possible, an amount of the first information to be acquired, and a timing of transmitting the first information to the counterpart device, based on the state of the communication channel.

12. The communication device according to claim 11,
wherein the cache processor controls the at least one based on a variation of the state of the communication channel.

13. The communication device according to claim 12,
wherein the cache processor controls the at least one on based on a degree of the variation of the state of the communication channel and a direction of the variation.

14. The communication device according to claim 11,
wherein the cache processor specifies the first information based on an information identifier directly or indirectly referred to from the information designated by the acquisition request, or information acquisition history of at least one of the counterpart device and another device.

15. The communication device according to claim 1,
wherein the communication device is an access point.

16. The communication device according to claim 1,
wherein the communication device is a terminal other than an access point.

17. A communication method comprising:
measuring a state of a communication channel with a counterpart device based on a frame communicated with the counterpart device via a wireless communication interface;
determining whether to transmit information pre-acquired for the counterpart device to the counterpart device based on the state of the communication channel; and
transmitting the information to the counterpart device via the wireless communication interface according to a determined result of whether to transmit the information to the counterpart device.

18. A non-transitory computer readable medium having a program stored therein which causes a computer to execute processing comprising:
measuring a state of a communication channel with a counterpart device based on a frame communicated with the counterpart device via a wireless communication interface;
determining whether to transmit information pre-acquired for the counterpart device to the counterpart device based on the state of the communication channel; and
transmitting the information to the counterpart device via the wireless communication interface according to a determined result of whether to transmit the information to the counterpart device.
